(19) United States
(12) Patent Application Publication
(10) Pub. No.: US 2014/0229305 A1
(43) Pub. Date: Aug. 14, 2014

(54) REAL TIME PAPERLESS PAYMENT CONTROL

(71) Applicant: Dilek Ellan, Singapore (SG)

(72) Inventor: Dilek Ellan, Singapore (SG)

(21) Appl. No.: 14/113,076

(22) PCT Filed: Apr. 23, 2012
(86) PCT No.: PCT/EP2012/057364

§ 371 Date: Apr. 30, 2014

(30) Foreign Application Priority Data
Apr. 21, 2011 (HK) 11104055.1
Apr. 25, 2011 (SG) 201102917-0
Apr. 28, 2011 (CH) 00724/11
May 20, 2011 (CH) 00856/11
Jun. 10, 2011 (CH) 00985/11
Jun. 17, 2011 (CH) 01036/11
Jun. 20, 2011 (US) 61498941

(51) Int. Cl. G06Q 20/04; G06Q 20/20

(52) U.S. Cl. CPC G06Q 20/0453; G06Q 20/204
USPC 705/17

(57) ABSTRACT

A real time paperless payment control and electronic receipt system for managing transaction receipts (20) issued by a point of sale (30), comprises the steps of providing an electronic receipt card to the consumer that comprises a consumer identifier, providing retailers with electronic means (30, 31) generating an electronic transaction receipt, transmitting the electronic transaction receipt (20) together with the costumers identifier to an electronic receipts storage means (41), providing at least one interface (35) to access manage and organize stored electronic receipts (20) within said electronic receipts storage means (41). It is characterized in that the electronic transaction receipt (20) generating electronic means (30) comprises an electronic funds transfer terminal (34; 35), in that said electronic receipt card is also a payment token usable within the electronic funds transfer terminal (34, 35) and comprising a consumer account identifier, wherein during a payment transaction a funds transaction code (24) is transmitted to the electronic funds transfer terminal (34, 35) adapted to forward said funds transaction code (24) together with the electronic transaction receipt (20) to said electronic receipts storage means (41), which can be a memory on the payment token or an external database.

### TECHNICAL FIELD

The present invention relates to an real time paperless payment control system for handling transaction receipts issued by a point of sale in a secure way, comprising the steps: providing an electronic receipt card to the consumer that comprises a consumer identifier, providing retailers with electronic means generating an electronic transaction receipt, transmitting the electronic transaction receipt together with the consumer identifier to an electronic receipts storage means, providing at least one interface to access, manage and organize stored electronic receipts within said electronic receipts storage means, according to the preamble of claim 1.

### PRIOR ART

Receipts are used in the commerce for a number of different purposes. They are handed over together with the purchased good as proof of payment. A receipt can then be used by a business traveler to claim a reimbursement from his employer. The receipt has a date and comprises such a proof of the date when the good has been purchased. This might be important for warranty issues or in the case that a good is exported to a different country, e.g. in view of VAT reimbursement. A further function of a receipt is the proof for the buyer and seller, that the price paid included federal or local taxes as well as VAT or further duties as e.g. prepaid recycling charges.

Usually such receipts are paper receipts. Electronic receipts are known within the e-commerce, when someone purchases a good in an online shop, especially an online activation or some other non-physical good or service.

One method and system is known from US 2010/0100434 providing an electronic receipt system allowing the customer to organize his expenses in an electronic way avoiding the management of paper copies which are usually printed on thermographic paper which is not really appropriate to provide a long term storage.

A further method and system according to the preamble of claim 1 is known from U.S. Pat. No. 6,341,353 providing a system with a specific organization of the entries of the receipt. The receipts according to this system are stored in a database.

These prior art systems provide storage solutions allowing for a simpler interaction between consumer and retailer in view of specific sales discount or claiming services or the guarantee for a purchased good.

Credit card organizations are not providing detailed information about the purchased goods to their customers, i.e. the holders of credit cards. Usually only date, time and amount paid are transmitted in the statement, accompanied by foreign currency information.

### SUMMARY OF THE INVENTION

Based on this prior art it is an object of the invention to provide a method and system improving the usability of the system. In fact transmitting a copy of an electronic receipt in a parallel way to a dedicated web site will not be accepted by a number of tax authorities to provide sufficient evidence for the expense. Usually business travelers on the user side and organizations and corporations on the other side are interested to have a secure system for managing expenses. Furthermore transferring specific data for a health service received by the customer is a critical issue.

Additionally it is an object of the invention to provide a direct connection between the expenses and the electronic proof for such an expense.

Furthermore it is a further object of the invention to allow the customer to have a direct control over the electronic receipts.

This object and further advantages are achieved with a method and system having the features according to claim 1, wherein the electronic transaction receipt generating electronic means comprises an electronic funds transfer terminal, said electronic receipt card is also a payment token usable within the electronic funds transfer terminal and comprising a consumer account identifier, wherein during a payment transaction a funds transaction code is transmitted to the electronic funds transfer terminal adapted to forward said funds transaction code together with the electronic transaction receipt to said electronic receipts storage means. Such a payment token can be an e-money card, e-money (using a prepaid amount stored in connection with an account number), a debit card (using an authorization of a deduction from an account), a credit card (using an authorization of charging an account), or a SIM card of a portable electronic communication device (using an authorization of charging an account connected with a phone number or a limited amount in case of a prepaid SIM card), or another payment authorizing token. The authorization can be granted through feedback from a clearing institution as with higher amounts for debit and credit cards, or a direct debit, where only the legitimacy of the card itself is checked and the deducted amount is communicated later on.

A payment means is characterized by the features of claim 9. A database system is characterized by the features of claim 13.

The invention is based on the insight that the user is interested to have one single card providing the payment information as well as the receipt handling. This also reduces the possibilities for fraud and therefore such a system is better accepted by corporations issuing corporate credit cards as well as by tax authorities. The system can therefore directly be used by a VAT refund corporation, since the data received are complete and the confirmed amount of the possible plurality of items is directly related to the possibly different VAT rates of the different goods and services. Therefore the customer can then, after having obtained the perhaps necessary export certification, directly obtain the refund since the refund organization is already in possession of a fraud proof receipt. The receipt comprises the itemized list of acquired goods and services with descriptive fields for—inter alia amount, VAT, kind of service and seller/provider codes, where available, as e.g. model number, serial number, service number etc. Not all of these fields are necessarily filled. It is important that the data is transferred in a possibly tamper proof way and, if it is directly written into a memory, it is even a privacy securing way to handle the itemized data.

According to one embodiment the itemized receipt is stored on the payment token or chip card directly. Usually the existing chip credit cards are processor cards having memory portions. It is possible to store the complete receipts in an additional memory chip to enable co-existence of the known credit-card chip and an additional memory or the itemized receipt is stored within the memory of the processor card itself. It is an advantage, when the debit card or credit card function of the processor chip is combined with an additional storage function which can be realized onboard within the same or an additional storage means or within an external database.

It is also possible to additionally store further information from the seller within the memory portion of the payment token with chip, e.g. warranty information, advertisement or coupons to be used later on. Thus the owner of the card is incited to manage the receipts and the further information through a later reading of the memory of the e-money card. It is also possible that this additional information is transferred together with the electronic receipt to an external receipt database according to one embodiment of the invention.

According to a preferred embodiment, the electronic receipt is digitally signed by the seller. This can be done within a one-chip solution or for a receipt stored within an additional memory card, in fact such a storage is equivalent to a storage in an “internal” database, i.e. on the chip. The storage can also be effected in an external database, wherein the transfer is automatically initiated during the payment transaction, wherein said transfer can also be protected by a digital signature.

A further possible use is based on the direct transfer of the data to a health care organization. Since the effected payment is directly connected to the single items of the medical treatment, the health care organization can verify the necessity to effect reimbursements for the itemized treatment steps within the list of goods (e.g. drugs) and services (e.g. care).

The invention is characterized by the fact, that the already existing credit card information can be used to generate the consumer identifier linking the information to the database as storage for the receipts. In fact the system is based on the insight that usually an account number is associated with a specific credit card. Now additionally a consumer number is also associated to such a credit card enabling the transfer of information to two different institutions, reflected technically by two distinct databases and communication channels. These communication channels start from the point of sale, where the unique card and relating information is gathered from the customer.

Of course it is possible to use a debit card instead of a credit card. These features can be freely interchanged. The main common feature of these cards, debit card or credit card, which can also be a prepaid card, is the possibility to obtain a service or a good with payment information relating to said card. Therefore it is possible that the card as such can also be a virtual card, in other words; the invention can also be used within internet based shops with the transfer of the card information instead of directly parsing the card through a point of sale device. Debit card and credit card as well as their virtual form can be defined as payment token having a chip, or e-money card. However, physical cards provide further advantages inherent to the fact that they can be used as data storage and transfer means.

The storage of the receipt within a memory on the card can then be supported providing an access means for the user, e.g. a card reader to extract the information from the chip card memory into an external memory. Within such an approach the user of the card has the entire control over his receipt data, which enhances the security but also has the drawback that the transfer to a third party database, e.g. a VAT refund company, a health care institution, his employers travel database or the customers own database, necessitates a personal action, i.e. reading his card.

It is an advantage using a standard chip card, e.g. according to ISO 7816, in order to provide a specific interface usable for the payment part of the method as well as usable for the storage part of the method. It is then advantageous that the storage part is protected under the same or further security means in the same or an additional chip within the same device or even the same token, e.g. the same chip card. This enhances the possibilities to avoid fraud in case that the data has to be transmitted in a tamper proof way, like it is often necessary, if the data relates to health care issues, VAT issues and/or personal data.

Besides using a credit card, it is also possible to use a cellular phone, smart phone or PDA, since these electronic devices comprise an electronic identification means. In fact it is possible to use the invention with any electronic device allowing a payment function. The payment function of the SIM card of a cellular phone is materialized through the contract of the user with the telephone provider company. This is even true for a prepaid SIM card, since this only limits the purchase power for goods and services to the prepaid amount.

Therefore the use of a SIM-card as payment token is also contemplated within the scope of the present invention. Furthermore, it is clear, that it is also possible to use any authenticating token as an e-money card according to the invention, if the payment can be effected based on that device.

Such a receipt hosting according to the invention enables companies to issue electronic receipts to their customer instead of paper receipts. These electronic receipts as all registered customer data are either stored on the chip card itself or are anonymously hosted on a database server.

According to an embodiment the customer himself can also access his data on the server of the database host. Customers have worldwide access to their receipts via interne. They can manage their receipts; they can print them in case for taxes or warranty of a purchased product. No permanent filing any more is also an evident advantage for the company's customer. Companies can save millions of costs and also profit from anonymous tracking of their customer habits. Today a lot of companies already have their own member card and track their customer. But they can not track their customers' consumer habits outside their shop. So companies benefit from receipt hosting 360° tracing, they save money and—last but not least—they profit from a more sustainable green image.

Customer can easily handle their receipts online anytime and anywhere. They can analyze there consumption as they like. They can group them for taxes, health care costs, eating habits. Companies profit from more information of their customer habits.

Customers can gain advantages from their hosted receipts as
travelling businessmen do not need to store thermographic paper receipts during their journey and/or to file such receipts all the time because they need them for accounting. This manages the easy handle of centralized receipts.
for many products it is necessary keeping receipts for warranty.
many other fields can be considered like full control over personal health care costs, better control about sugar consumption for diabetics, etc.

It is important that all data are hosted at the server of the system, since rivals in the market as well as customers will not accept that their personal data will be shared around the business world. The population is already very sensitive providing anybody with there personal data. The conclusion is that member companies send the e-receipt with customers' permission directly to the database within the server of the system. Once registered the customer has online access to all his data, can manage his receipts like private, business or as he like. All his receipts were stored as long as he likes on our server. A sales person can bundle his receipts for a business trip and invoice periodically his employer or using them for his tax declaration. Member companies on the other hand can use these anonymous data for sharpening their marketing data. Now they do not only track what their client is doing with them, but also his consumption elsewhere.

The server of the system can be the server of the issuer of the e-money card but this database host can also be outsourced. This is possible for a direct electronic transfer of the itemized receipt to that database but is also true for a card-based transfer via the memory on the chip card.

An electronic payment means for use with this method is adapted to be read and/or written by the electronic funds transfer terminal and comprises the information of the consumer account identifier and information for engaging a payment transaction. Usually there is an electronic memory for storage of the consumer account identifier. The electronic payment means is usually an EFTPOS (Electronic Funds Transfer at Point of Sale) card, being also called more specifically a credit card, a debit card, a deferred debit card, an ATM card or a charge card.

The electronic payment means for use with this method is not necessarily read and/or written by the electronic funds transfer terminal through a physical electrical contact. It is also possible to provide a wireless information transfer. This can be provided through RFID transmission, wherein usually the energy for the information transfer comes from the point-of-sale terminal is issued. It is also possible to provide the exchange of information through a wireless coded transfer as a message being sent to a smartphone and authenticated by the SIM-card.

It is possible to provide additional services in case that the user uses a chip card as payment means in connection with a communication device. This can be realized through a separate portable communication device as a smartphone which access number is stored within the receipt database. The receipt database comprises as such or derived from the stored information relating to data of bought goods and services. This information is a client profile, which changes dynamically through every purchase. Then additional information relating to the bought goods and services can be made available to the user, The receipt database can also be hosted by the payment institution. In a preferred embodiment, the communication means is a smartphone having a SIM card being used as payment means and adapted to directly receive the feedback communication based on the consumer/user's purchase profile stored within the receipt database. In short, the electronic receipt is transmitted to the electronic receipts storage means being adapted to generate an offer message which is transmitted to the device comprising the electronic receipt card being used in connection with an electronic communication means. The offer message can be created on the basis of information stored as offer information with the receipt database or can retrieve additional information from third parties. The profile of a user of the system is dynamically updated through every purchase on the fly and therefore after having generated one or more information messages relating to a restaurant, a newly generated message relating to e.g. a bar can be produced, if a transmitted receipt reveals that the user has visited a restaurant.

A further advantage of the dynamically updated database is an enhancement of security. After a first purchase based on a in-depth check of the identity of the consumer it is possible, based on the last entry or last entries of the receipt database, to make a simpler identity check, e.g. with a voice identification of the customer or acceptance directly, if the newly good to be purchased enters into the purchase pattern of the user, which is a clear indication, that it is the owner of the electronic payment means, i.e. a chip of a credit card, or a chip in a SIM card etc. who makes this further purchase.

The customer can decide, which receipts are transmitted to the database and thus comprise the basis for generated messages. Specific receipts can be transmitted on a one-to-one basis or in a coded way or specific types of receipts, having received a flag, are never transmitted or transmitted everytime, depending on the electronic flag stored in the receipt database. In other words, the customer is requested, either everytime upon a purchase or it is stored in a profile choice, to decide if a specific receipt request is transmitted to the receipt database or not.

It is possible, that the customer has three choices. The customer stores in his profile a general or type-coded acceptation de storage of receipts with issuance of message proposals relating thereto onto his communication device. The customer has a second possibility to store the transmitted receipts in a coded form, so that only the customer can retrieve the actual type of purchase. The customer can accept to receive generated messages onto his communication device based on the coded stored information. This comprises the creation of a customer profile as a data set in the receipt database, which can be coded or not. The third possibility is the creation of the receipt database for his personal consultation and refuse the generation and reception of such information messages based on the client profile.

It is also possible that the receipt storage itself is coded according to a predetermined ky. This can comprise a selection of entries depending of the kind of services, e.g. the customer may decide that all receipts relating to payment of public transport means are only stored with a code but without mention of kind of transportation means used (taxi, train ticket, air ticket), so that e.g. the travel of a journalist cannot be followed through discovery of the receipts. Other examples are possible to separate private and business costs. Then also these offers are not showing up in the offer information as shown above. Then the receipts are stored with coded information, which may be coded according to a predetermined code stored by the customer in the receipt database to be able to retrieve the coded values in clear text upon request. Then preferably these codes are protected by an additional password.

An electronic receipt system for use in connection with the cited method and using the mentioned electronic payment means for managing transaction receipts issued by a point of sale to a consumer within an electronic receipt system, comprises an electronic receipts database hosting a database providing electronic receipts which can be accessed by a consumer or customer with his electronic receipt cards based on a consumer identifier stored thereon. The system comprises electronic means generating electronic transaction receipts which are transferred with communication means to said electronic receipts database from the electronic funds transfer terminal or directly from the payment institution, which can be the local bank providing the EFTPOS terminal to the seller, the credit card institution or the bank of the buyer.

It is possible that one such electronic payment means for use with a method according to the invention is adapted to transmit the information after finishing the payment transaction to more than one receipts database.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows an example of data flow upon using an electronic receipt system as such;

FIG. 2 shows an embodiment of the system architecture;

FIG. 3 shows a system diagram showing an example of data flow upon using the system according to an embodiment of the invention; and

FIG. 4 shows a further example of a representation of the data flow using an electronic receipt system according to an embodiment of the invention.

### DESCRIPTION OF PREFERRED EMBODIMENTS

Different retailers use POS systems, which are integrated in a payment network. In fact at a point of sale, a so called EFT-POS-terminal for Electronic-Funds-Transfer-Terminal is available. According to prior art techniques said devices are connected during payment with a banking computer of the issuer of the card to authorize (or not) the intended transaction.

It is not necessary but possible, that the consumer himself is able to log into a computer system accessing the database within which the electronic receipts are stored. The authorization to access this database can also be given to the management of the corporate credit card in order to directly manage the expenses due to the use of their corporate cards. The system is also intended to be run by a VAT refund company receiving the receipts from the point-of-sale in the framework of a trilateral agreement. The customer has an e-money card issued by the payment organization. He also has an agreement with the VAT refund company, allowing the storage of the specific receipts on their database for use with the tax authorities to obtain a refund. Then the tax refund company contacts the customer for payment of the refund. Therefore there is no direct need for the customer to check and manage the receipts in the tax refund company's database. This is especially true, if the refund is done via the credit card issuing company. However, for data privacy reasons, possibility of a data access is sometimes required or mandatory.

The same approach is possible within the health care system, if the data concerning the payment is directly transferred with an itemized list of health care services and goods to the database of the health care insurance company to check the possibility of reimbursements. It is possible to transfer the receipts depending on the services/goods to different databases or to one single database, wherein different entities having different access rights, e.g. the database can have a tax refund portion, a health care related invoice portion and a private receipt database portion.

The general steps relating to the transfer of an electronic receipt are as follows. Initially several steps occur during the payment transaction, which are known as such within the prior art:
the goods and/or services which are to be paid are registered locally within a cash register.
the consumer shows sales discount vouchers, gift coupons etc. as well as a payment means. Such a payment means comprises an e-money card having a connection with either e-money (prepaid amount stored in connection with an account number), a debit card (authorization of a deduction from an account), a credit card (authorization of charging an account), or a SIM card of a portable electronic communication device (authorization of charging an account connected with a phone number or a limited amount in case of a prepaid SIM card), or another payment authorizing token.
the payment is to be authorized by the issuing or handling organization in a known way.
the payment transaction is effected.
the transaction code is transferred as proof of successful payment.
according to prior art, the payment receipt comprising the transaction code is printed, and is handed over within a paper receipt.

This method is now amended according to an embodiment of the present invention.
the goods and/or services which are to be paid are registered locally within a cash register and details relating to specific goods/services are temporarily stored.

the consumer shows sales discount vouchers etc. as mentioned above
the payment is to be authorized by the issuing or handling organization in a known way. At that point the consumer identifier is also checked for issuance of an electronic receipt. Said communication request can be effected either directly within a second communication channel with the electronic receipt database or it is indirectly requested through the payment institution. Then a flag is transmitted to the server of the payment institution triggering a request from said server with the server and database of the electronic receipt institution. Then the membership information. e.g. a consumer identifier is transmitted via the payment institution to the POS terminal
the payment transaction is effected as above.
the transaction code is transferred as proof of successful payment.
the transaction code and information is not printed anymore (although this remains an additional optional step) and the data relating to the goods/services, the transaction code as well as the consumer identifier is transmitted to the database of the electronic receipt server, which can be e.g. a server of a tax refund company for having a direct payment proof for goods which has only to be joined by an export certification for effecting a refund payment. It can also be the server of a health care organization, which is then directly in measure to calculate a reimbursement for the medical care services according to a health care agreement of the customer. The transfer can also be a direct transfer to a memory portion of the chip card or e-money card used to effect the payment. In other words, instead of handing over a paper receipt, the electronical data can be stored within the memory of the e-money card.

Of course, it is possible that the transfer of the data to the electronic receipt server does not happen at that very moment online but is postponed to a later moment in time, e.g. daily. It is also possible that the consumer identifier is not verified online, but calculated offline to be a valid number. In the case that the itemized receipt information is stored within the memory of the e-money card, the transfer to an electronic receipt server is also postponed until the user of the e-money card decides to effect such a transfer using a card-reader/writer. It is possible that the card reader is also a card writer to delete extracted itemized receipts.

Preferably the information transferred from the POS terminal to the electronic receipt storage means, e.g. the memory on the chip card or the external database, is electronically signed to enable a later authentication check.

The data transfer to an external database can be initiated by signed messages like email, short messages etc. It is also possible that the receipt is initially transferred to a mobile smart phone, having the SIM card, of the customer and is only subsequently transferred to the database of the company, even in the case of the tax refund company, since it is possible to encapsulate the message in a tamper-proof envelope, using the customer's smart phone as a valid intermediate storage device. This is possible, since it is in the customer's interest to initiate, when technically possible, the transfer of the receipts to the database, either for his personal perusal or for the use of the company for e.g. reimbursement purposes.

In this context it is possible that the e-money card is also directly usable to create the export certificate, if a terminal capable of identifying the e-money card is installed with the relevant local customs authorities to identify a specific receipt. Then it would be possible to intermediately store a copy of the receipt for access by the customs authorities so that they can directly provide an export flag to be added to the data set.

According to one embodiment the consumer can then use his identifier to logon directly into the (eventually optionally further) electronic receipt database to manage his receipts. It is also possible that third persons, i.e. corporate accountants can access the data, and that deletions of data are not authorized for the consumer itself. In the case that the itemized receipt is stored within a memory on the chip, said transfer to a further database is initialized through such a logon to an electronic receipt database.

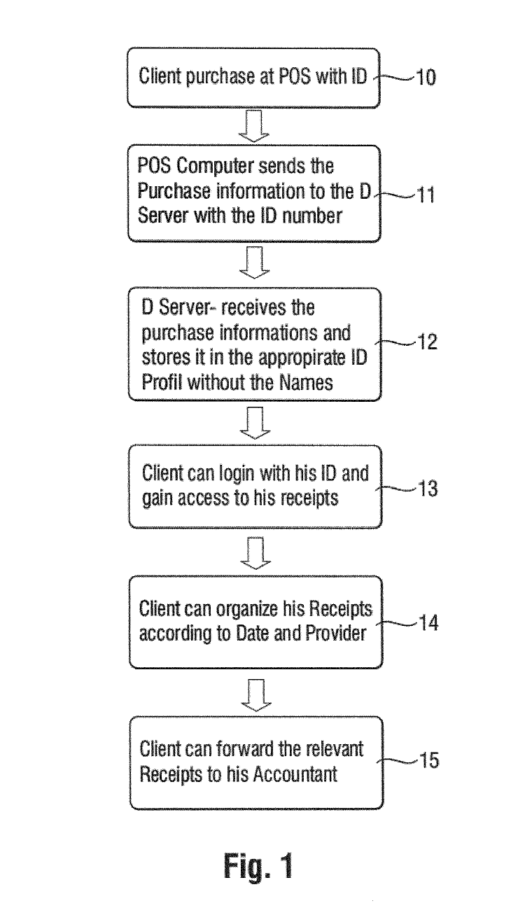

FIG. 1 shows a system diagram referring to the data flow and the interaction between the user using an electronic receipt system with a retailer or seller of a good or provider of a service. Client purchases in a store and hands over his customer identifier number in a step 10, preferably printed as a barcode, within a magnetic strip or in a chip stored on a card.

The purchase can also comprise acquiring services and also comprise health care services and medication treatment.

The receipt is assembled using information relating to the goods purchased and the customer identifier. This information including the number is transferred to the electronic receipt server as step 11. The electronic receipt server receives said information and stores it in its database as step 12.

The client has the necessary information to login in the electronic receipt server and accesses the portion within the database relating to the electronic receipts for the customer identifier as step 13.

In the case that the client is the customer, he has than according to the cited prior art different possibilities to manage his receipts as step 14 and can finally use the electronic receipts for his accountant in case of business expenses to be charged and paid by his business in step 15.

In the case that the client is a tax refund company or a health care organization or a similar business, the data sets stored within the database can be executed according to the existing agreement with the customer, which may or may not include a right to the customer to effect reading, writing or further actions on the data.

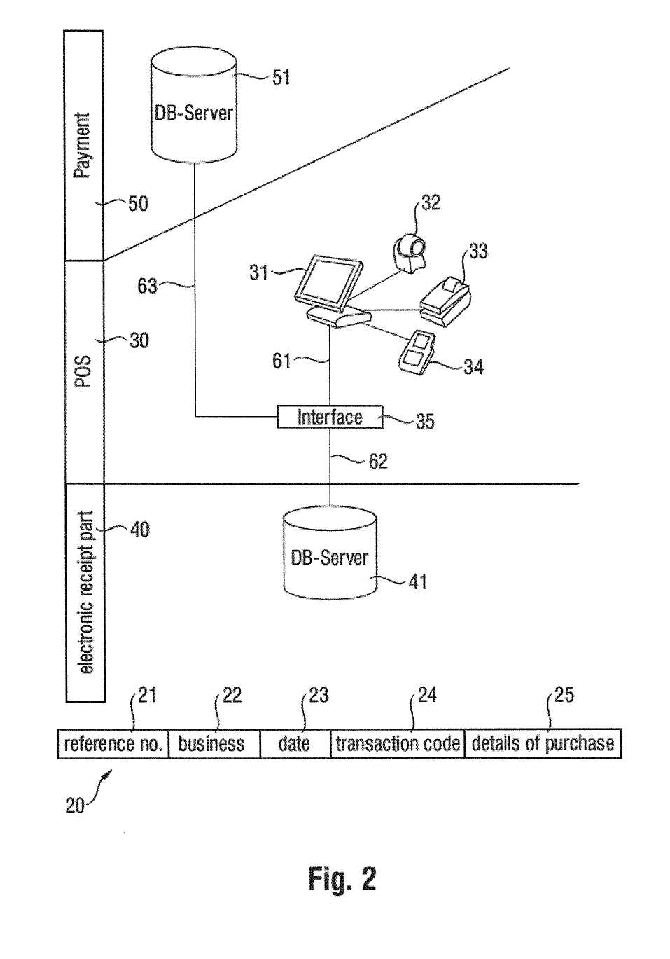

FIG. 2 shows an embodiment of the system architecture together with an example of a data structure 20. The system architecture comprises a point of sale part 30, an electronic receipt part 40 and a payment part 50.

The point of sale part 30 comprises a cash register 31 and a credit card terminal 34 and may comprise a scanner 32 and a printer 33. It is possible that the point-of-sale only has some of these devices, only a terminal 34 and the connection with the interface 35 are mandatory. The terminal 34 can be as shown a credit card/debit card terminal or an authentication device for a different e-money payment means as a SIM-card or a different credit giving token.

The electronic receipt part 40 comprises an electronic receipt server 41 comprising a database. This database can be an external database or it can be realized by a memory portion within the e-money card, implemented within one processor chip used to effect the communication with the payment part 50 or as an additional memory chip, which can have a protected memory.

The payment part 50 comprises a payment server 51 comprising a database, usually related to the payment institution. Of course the payment server 51 is not accessed directly and comprises a number of different known communication devices in between. In fact the payment server 51 is synonymous for the electronic information within the payment institution relating to a specific customer account and the relating personal and financial information. This can also be a database of a telecom company allowing payments based on a contractual agreement in connection with a SIM-card of a communication device.

During the sale the cash register 31 contacts an interface or control unit 35 over communication line 61. The control unit 35 can be within the premises of the shop but can also be in an external building and accessed over communication channels 61 as a telephone line or a packet distributed network or the internet. Said control unit 35 is adapted to access with the help of a communication channel 62 the electronic receipt server 41 for the exchange of the electronic receipt 20, having the data structure as will be explained later on. Said control unit 35 is further adapted to access with the help of a further communication channel 63 the payment server 51 for the exchange of the electronic cash information having a data structure as will be known by a person skilled in the art.

The electronic receipt 20 according to an embodiment of the invention comprises a reference number 21 of the receipt itself, a POS identifier 22, the date 23, one or more transaction codes 24 and the details of the purchase 25. e.g. the list of items bought with relevant price and identification information. The one or more transaction codes 24 comprise at least the transaction code issued by the financial payment institution, i.e. from the payment server 51 but can also comprise a POS transaction code relating to the selling institution. The above mentioned fields 21 to 25 of the electronic receipt 20 are usual values having a defined field structure according to the needs of the transfer or storage of the entries.

In the case of a health care application, the fields 25 comprise usual health care product codes and information relating to costs therefore.

In the case of a tax refund application, the fields 25 comprise also VAT rates. If—as mentioned above—the specific data set 20 is also accessible for customs authorities to check the list of exported goods to deliver an export certification, then the data set 20 and/or the field 25 comprises an additional flag comprising the decision of the customs authorities of deliverance of an export certification which then allows the tax refund company working on the data sets within the database server 41 to reimburse the customer. In other words, the electronic receipts database comprises an access for a third party allowing adding an electronic flag to each data set having a specific transaction code.

The invention comprises at least the two following storage approaches. The database server 41 is an external server as explained above. The database server of the tax refund company, health care organization etc. is a further database server which receives the itemized receipts from the card holder directly, since the receipt is stored on the e-money card as storage means 41 and can or is only transferred later on to said further database server.

The storage of the receipts 20 on the data-chip of the payment token, which can be an e-money card or SIM card or a memory enhanced processor chip, improves the security especially, if the data is digitally signed and/or encrypted so that only the owner of the card can access the data, especially is the only person able to provide the necessary access codes to copy/extract the receipts 20 from the e-money card to a further electronic database. This requires use of a card reader and preferably a card-reader/writer through the user.

It is also possible that the payment institution 51 has the details of purchase, so that their computers can detect changes in behavior more easily and more rapidly, thus increasing security also in the case of theft of the card. Therefore the data can be transferred to the memory on the card as storage means 41 together with a 1:1 copy of the data transmitted to the payment institution 51, allowing to restore the card in case of destruction or loss, since the itemized receipts are then also stored within the payment institution 51.

The electronic receipt system can either be adapted that the electronic funds transfer terminal, i.e. with its part as the interface 35, connects with a server 51 of the payment institution issuing said e-money card to receive from said server 51 said funds transaction code 24 to be transferred to the database.

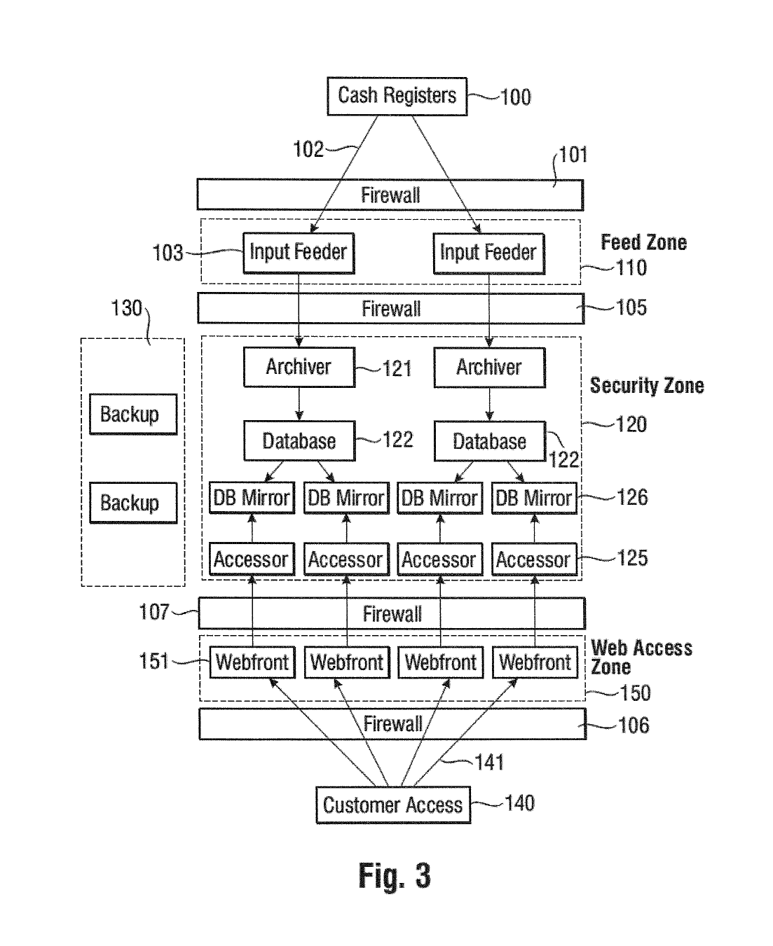

The electronic receipt system can also be adapted in a different way, which is not shown in FIG. 3. The electronic funds transfer terminal 35 is adapted to be connected with said server 51 of the payment institution issuing said e-money card to initiate within said server the generation of said funds transaction code 24. However, then said funds transaction code is directly transferred to said electronic receipts database 41, i.e. with a communication channel between the entities 51 and 41 which is not shown in the drawings. This would enable a time differed transfer of the information which can then be reassembled in the database 41 through knowledge of the customer identifier and/or the reference number 21, which should in this case also be transferred to the payment institution 51.

In case of use of a SIM card base electronic device, it is also possible to transmit the electronic receipt from the electronic funds transfer terminal via an RFID or NFC connection with an interface not shown in the drawings to the electronic device in question using the SIM card and wherein the electronic device, i.e. a cellular phone, a PDA or another identifiable electronic device having received this transaction code 24 and electronic receipt from the electronic funds transfer terminal directly or indirectly to the database. Said transmission can be sent by email or by a packet related transmission initialized by the electronic device of the user to the database of the electronic receipt server 41. The SIM card is then considered to be an e-money card. Within this context, the electronic receipt can be stored in a memory means provided within the e-money card or the electronic device having said token (SIM-card). Since the electronic receipt can be digitally signed and/or encrypted, such a temporary storage allows a later synchronization/transferral of these data to the database server.

In this context it is an advantageous embodiment to provide additional services to the customer using a cellular phone, PDA etc. The communication channel used to conclude the transaction can be directly used for the following or the access number of the electronic device is stored within the receipt database and used to reopen a communication channel. Then additional information relating to the acquired goods and services can be made available to the customer based one the customer profile construed based on former transactions of the user. The offer message can be created on the basis of information stored as offer information with the receipt database or can be retrieved as additional information from databases of third parties.

FIG. 3 shows a system diagram referring to the data flow and the interaction between the user using the system and the retailer or seller of a good or provider of a service.

The cash register(s) 100 are protected by a firewall 101 when transmitting their electronic receipt information 102 to an input feeder 103 in a feed zone 110. The feed zone 110 is separated from a security zone 120 by a further firewall 105. The electronic receipt information is fed to an archive application 121 for storing it in a database 122. FIG. 3 shows two databases 122 for security and backup reasons. Of course further backup means 130 are provided.

The customer access 140 is usually a web application, accessing via 141 through a firewall 106 a web access zone hosting a number of web fronts 151. These web fronts access via a further fire wall 107 accessors 125 for reading and writing, in fact managing the electronic receipt information, within a database mirror 126 of the database 122.

In this context, the customer access 140 can be the customer having purchased goods, it can be the health care provider checking the reimbursement, and it can be the customs authorities for identification of a customer asking for an export certification allowing a verified secure communication of such a flag for the export certification into the dataset.

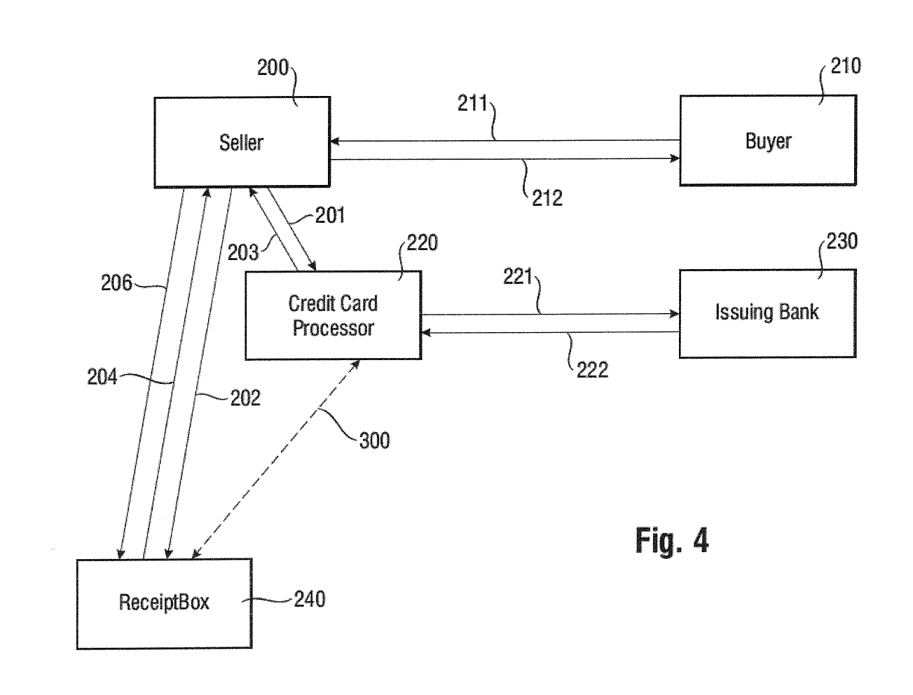

FIG. 4 shows a further example of a representation of the data flow using an electronic receipt system according to an embodiment of the invention. The consumer or buyer 210 presents 211 the goods and/or shows sales discount vouchers etc. to the seller 200. The goods and/or services which are to be paid are registered locally within a cash register and details relating to specific goods/services are temporarily stored by the seller 200.

The payment is to be authorized by the issuing bank 230 or handling organization either directly or as shown in FIG. 4 through a credit card institution 220. This comprises usually two authorization requests 201 and 221. For credit cards, usually the authorization of the payment and the payment itself, the so called settlement, is separated in view of the different contractual binds. The retailer may transfer the authorization request initially to his own banking institution from which he has the POS-terminal which then contacts the credit card processor 220 who then requests approval for the purchase with the issuing bank, where the card holder has an account or a credit.

At that point the consumer identifier is also checked for issuance of an electronic receipt. Said communication request can be effected as shown in FIG. 4 within a second communication channel 202 as a membership query with the electronic receipt database 240 or it is indirectly requested through the payment institution; either 220 or 230. Then a confirmation of membership 204 as e.g. a flag is transmitted to the seller 200.

The receiptbox database 240 can be the external server receiving a data transfer through the net or the database 240 can be the storage means on the e-money-card or within the device hosting the e-money-card, e.g. a smart phone. In the latter case there is no net transfer but a direct writing access of the e-money card memory by the POS terminal. In the case of an e-money-card within a SIM card of the smart phone the write transfer of the itemized receipt can nevertheless be a near-field transfer, by Bluetooth or another wireless preferably encrypted data transfer. It is also possible that the e-money-card only accepts contact chip card transfer over ship contacts as e.g. standardized as in ISO 7816. Then all data can be protected with a password known to the owner of the card.

The request 221 is answered by the bank with either a denial or an authorization confirmation 222 which is then handled and forwarded as authorization confirmation 203 to the seller. In fact, the server of the payment institution 220/230 triggers the deliverance 206 of the electronic receipt to the database of the electronic receipt institution 240. The goods are handed over 212 to the buyer 210.

In fact, the reference numeral 200, the seller, relates in fact to the unique POS terminal transferring the membership information as well as the payment information. According to a preferred embodiment the consumer identifier is transmitted via the payment institution 220 to the POS terminal. This is symbolized within FIG. 4 with the dotted double arrow 300. This arrow 300 represents the shift of the information transfer 202, 204 and 206 from the database of the electronic receipt server 240 towards the server of the credit card processor 220, enabling a direct transfer of the specific buyer information contained in the data sets having the data structure 20 via the POS terminal and the credit card organization 220. It would also be possible to shift this transfer 300 to a communication between receipt box server 240 and the banking institution.

The payment transaction via the clearing and the settlement is performed according to prior art and is therefore not shown in FIG. 4.

The communications “authorization request 201” and “authorization confirmation 203” can be realized via RFID, NFC or Bluetooth transmittal means provided in the payment device of the buyer, e.g. a cellular phone, smart phone or PDA. The communication 201 can also be realized in a wireless manner when a card document as a credit card is used, since RFID transmittal can be included in the body of the card. Storage of the itemized data in a magnetic strip on such a card or on a device is also possible.

The transaction code is transferred as proof of successful payment according to the information channel 206 and/or 300 to the database 240 and can be shown as visual information within the POS terminal. The reference number 21 in the data structure 20 is then used to indicate a number of different goods in transaction codes 24 and details of purchase 25.

Additionally the electronic receipt is digitally signed. This means that the seller, e.g. it's electronic funds transfer terminal, is adapted to prepare a message hash of the information contained in the receipt, to encrypt the hash with his private key that he has previously obtained from a public-private key authority, so that the encrypted hash becomes the digital signature of the message. In this way it is ensured that the electronic receipt database 122 stores electronic receipts having a verifiable content, so that it can be directly used as authentic proof of expense.

It is possible that the receipts 206 are not only transferred to the database of the receipt box 240, but also or instead to a database of a third party, as e.g. the employer of the credit card user. Then it is possible, that the travelling businessmen do not need to store receipts during their journey and to file such receipts with his firm's accountant, but that such receipts are transferred in a centralized process. It is also possible that the data transfers to the receiptbox database of the user and the receiptbox database of the firm uses different communication means, as email and packet transfer.

It is also possible to use the system for different data in relation with payment requirements, e.g. not for the transfer of buying receipts but for receipts of health care services. In fact, in such a situation the data would be transferred to the user's account in the database 241 and as well to the health care insurance data base which would usually be a second database, accessible for the insurance employee's and if authorized to the patient in question.

The method according to the invention take more potential if the electronic receipt transmittal 206 is also provided to a database of the customs authorities to allow adding said export certification flag to the data set. A different solution would be the (web) access of the customs authorities directly or through the buyer 210 to said dataset, wherein the customs services apply their export certificate information to said dataset, e.g. electronically signing the dataset of the buyer 210, e.g. through digitally signing the receipt 20 provided by the customer on his mobile phone by transmitting and adding said signature electronically to the data set in question, or triggering e.g. a web access to the tax refund database through providing an access code through the electronic device of the buyer 210. This can be done through information provided by the smart phone, secured by the SIM card, or it can be provided through the credit card for accessing the database and/or a specific data set at such an export point. The data can in any case also be stored in a magnetic strip on the card, separately from a chip and separately from a possible RFID antenna.

The database mentioned as receiptbox 240 in the context of FIG. 4 can also be the database of the VAT refund company or of the health care insurance company, i.e. the database 240 is not directly connected to the buyer 210 who has access via his contractual agreement with the database host. The invention therefore combines a secured data flow between four entities, the buyer 210, the seller 200, the payment institution 230 (e.g. a bank, a telecom company, a credit allowing entity) and the interested host 240, which can be a tax refund company, a health care insurance, an electronic receipt managing company or a private database for the customer/buyer.

### LIST OF REFERENCE SIGNS

10 to 15 steps within the electronic
receipt architecture
20 data structure
21 reference number
22 POS identifier
23 date entry
24 transaction code
25 details of purchase
30 point of sale part
31 cash register
32 scanner
33 printer
34 credit card terminal
35 control unit/interface
40 electronic receipt part
41 electronic receipt server
50 payment part
51 payment server
61 to 63 communication channel(s)
100 cash register
101 firewall
102 receipt information
103 input feeder
105 to 107 firewall(s)
110 feed zone
120 security zone
121 archive application
122 electronic receipt database
125 accessor
126 database mirror
130 backup means
141 web access
150 web access zone
151 web front
200 seller
201 authorization request
202 membership query
203 authorization confirmation
204 membership confirmation
206 electronic receipt transmittal
210 buyer
211 presentation of goods
212 hand-over of goods
220 credit card institution
221 authorization request
222 authorization confirmation
230 issuing bank
240 receipt database server
300 connection shift

1. A real time paperless payment control method managing transaction receipts issued by a point of sale within an electronic receipt system, comprising the steps:
providing an electronic receipt card to the consumer that comprises a consumer identifier,
providing retailers with electronic means (30) generating an electronic transaction receipt (20),
transmitting the electronic transaction receipt (20) together with the consumer identifier to an electronic receipts storage means (41; 122),
providing at least one interface (140, 150) to access, manage and organize stored electronic receipts (20) within said electronic receipts storage means (41; 122), characterized in that the electronic transaction receipt generating electronic means (30) comprises an electronic funds transfer terminal (30, 34, 35), in that said electronic receipt card is also a payment token usable within the electronic funds transfer terminal (30, 34,35) and comprising a consumer account identifier, wherein during a payment transaction (63) a funds transaction code (24) is transmitted to the electronic funds transfer terminal (30, 34, 35) adapted to forward said funds transaction code (24) together with the electronic transaction receipt (25) to said electronic receipts storage means (41; 122).

2. The method according to claim 1, wherein the electronic receipts storage means (41, 122) is a memory storage means within the payment token or a device hosting the payment token, wherein the electronic receipt is stored in said memory means provided within the payment token, especially for a temporal later transfer to an electronic receipts database (41), especially transferred through a card reader to the electronic receipts database (41).

3. The method according to claim 1, wherein the electronic receipts storage means is an external database (41, 122).

4. The method according to claim 1, wherein the electronic receipts storage means or the external database comprises (41; 122) an read or read/write access, particularly a web access (150), for the customer or a third party using at least the consumer identifier as a means of identification.

5. The method according to claim 1, wherein the electronic receipts database comprises (41; 122) an access (150) for a third party allowing adding an electronic flag to each data set having a specific transaction code (24).

6. The method according to claim 1, wherein the electronic funds transfer terminal (35) is adapted to be connected with a server of the payment institution (51) issuing said payment token to receive from said server said funds transaction code (24).

7. The method according to claim 1, wherein the electronic funds transfer terminal (35) is adapted to be connected with a server (51) of the payment institution issuing said payment token to initiate within said server the generation of said funds transaction code (24) for a direct transfer of the electronic transaction receipt (25) to said electronic receipts storage means (41).

8. The method according to claim 1, wherein the electronic receipt is digitally signed by the seller through said electronic funds transfer terminal (30, 34, 35).

9. The method according to claim 1, wherein based on the electronic receipt the electronic receipts storage means (41) is adapted to generate an offer message which is transmitted to the device comprising the electronic receipt card being used in connection with an electronic communication means.

10. A real time paperless payment electronic payment means for use with a method according to claim 1, adapted to be read and/or written by the electronic funds transfer terminal (30, 34, 35), comprising the information of the consumer account identifier and comprising information for engaging a payment transaction (63), wherein optionally the payment means comprises an electronic memory for storage of the consumer account identifier and/or the electronic receipts storage means.

11. The electronic payment means according to claim 10, adapted to authorize within the electronic funds transfer terminal (30, 34, 35) the generation of a funds transaction code (24) together with an electronic transaction receipt (25) to at least one electronic receipts storage means or database (41; 122).

12. The electronic payment means according to claim 10, being a credit card, a debit card, a deferred debit card, an ATM card, a charge card, a SIM card or a credit allowing electronic token.

13. An electronic receipt system, comprising for executing the method according to claim 1, for managing transaction receipts issued by a point of sale within an electronic receipt system, comprising:
electronic receipt cards for each consumer comprising a consumer identifier,
an electronic receipts database (41; 122) hosting a database providing electronic receipts,
electronic means (30) generating electronic transaction receipts (20),
communication means, adapted to transmit electronic transaction receipts (20) together with the consumer identifier to said electronic receipts database (41; 122),
an interface (140, 150) to access, manage and organize stored electronic receipts (20) within said electronic receipts database (41; 122),
characterized in that
the electronic transaction receipt generating electronic means (30) comprises an electronic funds transfer terminal (30, 34, 35),
said electronic receipt card is also a payment token usable within the electronic funds transfer terminal (30, 34, 35) and comprises said consumer account identifier and optionally memory means provided within the payment token to directly store the electronic receipt, especially for a temporal later transfer to an electronic receipts database (41), especially transferred through a card reader to the electronic receipts database (41).

14. The electronic receipt system according to claim 13, wherein the interface (140, 150) is a web interface.

15. The electronic receipt system according to claim 13, wherein the electronic funds transfer terminal (30, 34, 35) is adapted to connect with a server of the payment institution (220 or 230) and said server of the payment institution (220 or 230) is further adapted to transmit electronic transaction receipts (20) together with the consumer identifier to said electronic receipts database (41; 122), wherein the consumer identifier as well as the transaction data is received from the electronic funds transfer terminal (30, 34,35), wherein optionally said server of the payment institution (220 or 230) is adapted to check (202) the existence of an account within the electronic receipts database (41; 122) for said consumer identifier for issuance of an electronic receipt.
